(19) United States
(12) Patent Application Publication
(10) Pub. No.: US 2006/0091637 A1
(43) Pub. Date: May 4, 2006

(54) Apparatus and method for providing a step for a vehicle

(76) Inventor: Gregory Knittel, Napa, CA (US)

Correspondence Address: Trellis Intellectual Property Law Group, PC, 1900 EMBARCADERO ROAD, SUITE 109, PALO ALTO, CA, 94303, US

(21) Appl. No.: 11/246,034

(22) Filed: Oct. 7, 2005

Related U.S. Application Data
(63) Continuation-in-part of application No. 10/965,061, filed on Oct. 14, 2004.

(51) Int. Cl. B60R 3/00

(52) U.S. Cl. 280/163

(57) ABSTRACT

An apparatus and method for providing or furnishing a step for a vehicle. The method for furnishing a step for a vehicle comprising providing a vehicle having a hitch assembly including a hitch member engaged to a receiver assembly, removing the hitch assembly from the receiver assembly and engaging a step assembly to the receiver assembly. The step assembly comprises a step body and a step support bar connected to the step body. The step body is manufactured from a foam material and may include a cavity wherein a light member lodges for illumination purposes. A recess is formed in the front of the step assembly. The rear wall of the recess is transparent to allow light to pass when the light member is illuminated. The rear wall may support a sensor, as well as a decal member.

This is a continuation-in-part patent application of co-pending patent application having application Ser. No. 10/965,061, filed Oct. 14, 2004. Benefit of the earlier filing date is claimed for all common subject matter.

### BACKGROUND OF THE INVENTION

1. Field of Invention

The present invention relates in general to a step upon which a person may elevate himself or herself. More specifically, embodiments of the present invention relate to an apparatus and method for providing or furnishing a step coupled or engaged to any suitable vehicle (e.g., trucks) or to any other suitable support.

2. Description of the Background Art

Trailer hitches typically include a hitch member which slidably engages a conduit receiver member connected to the underside of a vehicle in proximity to the bumper. The hitch member typically includes a ball member that removably engages a tongue of a trailer or any other suitable vehicle. After a trailer is disconnected from the hitch member, a person may wish to step on the hitch member to get closer to an area of a vehicle, such as the flat bed of a pick up truck. The hitch member does not provide a suitable step for a person, as the ball is a non-planar member (i.e., a spherical member). Thus, what is needed and what has been invented is a step assemble for providing or furnishing an improved step upon which a person may step.

### SUMMARY OF EMBODIMENTS OF THE INVENTION

Embodiments of the present invention provide a method for furnishing a step for a vehicle comprising providing a vehicle having a hitch assembly including a hitch member engaged to a receiver assembly, removing the hitch assembly from the receiver assembly, and engaging a step assembly to the receiver assembly for furnishing a step for the vehicle.

Embodiments of the present invention provide a step assembly comprising a step body and a step support bar connected to the step body. The step support bar includes a generally hollow support bar having a pair of opposed openings. The step body comprises a generally planar top and a front defining an arcuate surface. The step assembly additionally comprises a vehicle having a receiver assembly including a generally hollow member having a pair of opposed apertures. The generally hollow support bar is slidably engaged with the generally hollow member and a pin passes through the opposed openings of the generally hollow support bar and through the opposed apertures of the generally hollow member.

Embodiments of the present invention also provide a step assembly manufactured from a compressible foam material (e.g., styrofoam, etc.) that is resilient for returning to its original position if disturbed (e.g., contacted by a bumper of another vehicle, etc.). The step assembly includes a cavity in which a light member resides, and a conduit member through which one or more wires pass for electrically connecting to the light member. The step assembly also includes a recess whose bottom or rear wall is a generally transparent plastic or metal wall member through which light may pass when the light member is illuminated. A decal member may be mounted on the plastic or metal wall member, and a backup sensor may extend through, lodge in, or be supported by the plastic or metal wall member or any other suitable part of the step assembly. One of the wires passing through the conduit member may be coupled to the backup sensor for powering the same when electric current flows through one of the wires from the battery of the vehicle.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only, wherein:

### BRIEF DESCRIPTION OF THE DRAWINGS

FIG. 1 is a perspective view of the step assembly coupled to a receiver assembly connected to the underside of a vehicle in proximity to a bumper.

FIG. 2A is a perspective view of a hitch member after being slidably disengaged from the receiver assembly.

FIG. 2B is a perspective view of the step assembly spaced from and aligned with the receiver assembly for slidably engaging the same.

FIG. 3 is a top plan view of the step assembly and a partial horizontal sectional view of the receiver assembly illustrating the step assembly coupled to the receiver assembly, in accordance with various embodiments of the invention.

FIG. 4 is a bottom plan view of the step assembly, in accordance with various embodiments of the invention.

FIG. 5 is an end elevational view taken in direction of the arrows and along the plane of line 5-5 in FIG. 3.

FIG. 6 is a perspective view of another embodiment of the step assembly coupled to a receiver assembly connected to the underside of a vehicle in proximity to a bumper.

FIG. 7 is a rear perspective view of the embodiment of the step assembly of FIG. 6.

FIG. 8 is a front elevational view of the step assembly of FIG. 6.

FIG. 9 is a top plan view of the step assembly of FIG. 6.

FIG. 10 is a vertical sectional view taken in direction of the arrows and along the plane of line 10-10 in FIG. 9.

FIG. 11 is a vertical sectional view taken in direction of the arrows and along the plane of line 11-11 in FIG. 9.

FIG. 12 is a vertical sectional view taken in direction of the arrows and along the plane of line 12-12 in FIG. 9.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

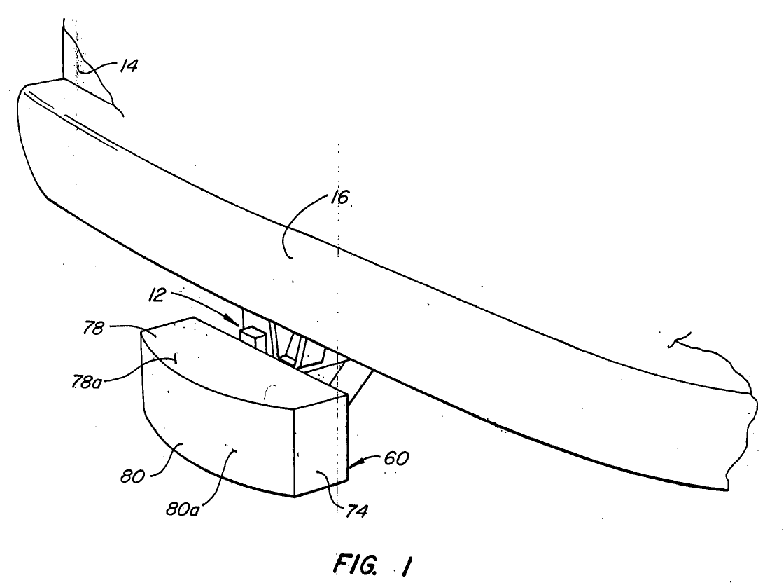

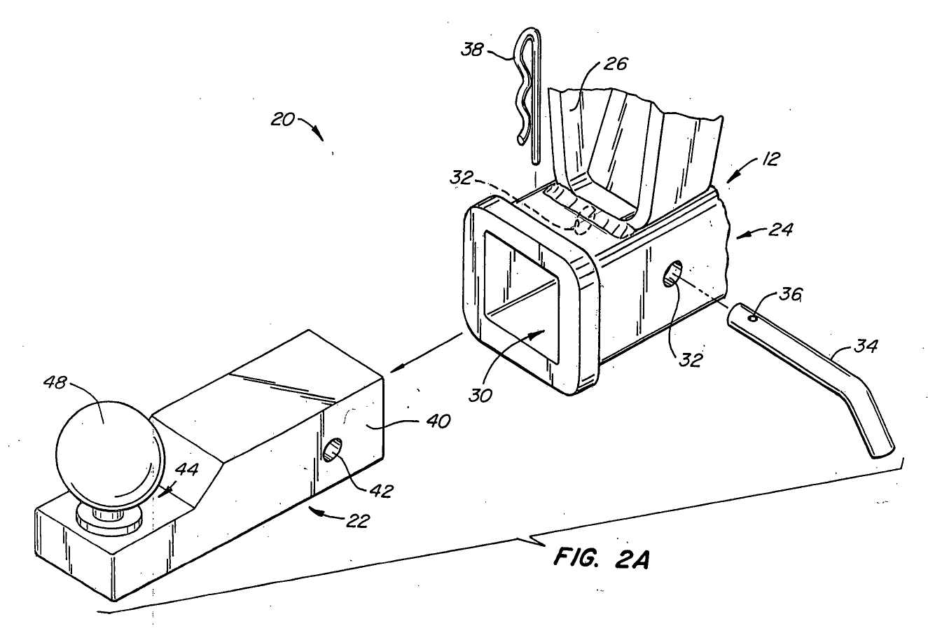

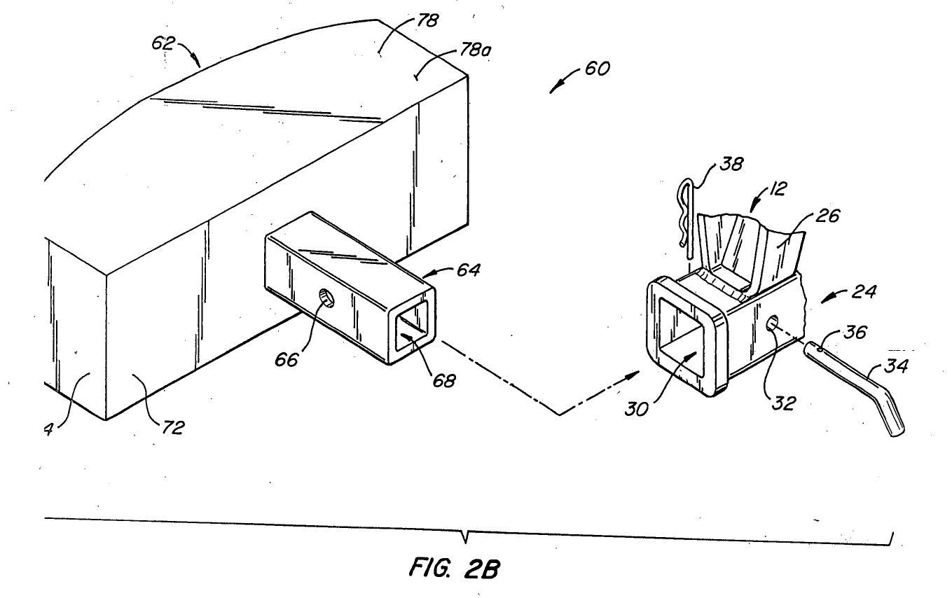

Referring in detail now to the drawings, there is seen in FIG. 1 a perspective view of the step assembly, generally illustrated as 10, coupled to a receiver assembly, generally illustrated as 12. The receiver assembly 12 is connected to the underside of a vehicle 14 in proximity to a bumper 16 supported by the vehicle 14. Referring now to FIG. 2A there is seen a hitch assembly, generally illustrated as 20, comprising the receiver assembly 12 and the hitch member 22. The receiver assembly 12 includes a female conduit member 24 connected to a support bracket 26 that connects to the underside of the vehicle 14 which is in close proximity to the bumper 16. The female conduit member 24 has an essentially hollow inside, generally illustrated as 30, and a pair of opposed aligned apertures 32-32 for receiving a pin member 34 having an opening or a bore 36 passing there through. A clip or coupling pin (e.g., a Carter pin) 38 passes through the bore 36 after the pin member 34 passes through the hitch member 22 and the opposed apertures 32-32. The pin member 34 and the coupling pin 38 represent, by way of example only, a coupling assembly for coupling the hitch member 22 to the receiver assembly 24. The hitch member 22 includes a hitch body 40 having an opening 42 extending there through and a recess 44 positioned at an end of the hitch body 40. A hitch ball member 48 is coupled to the hitch body 40 within the recess 44. The hitch body 40 slidably passes into the hollow inside 30 of the conduit body 24 until the opening 42 is aligned with the pair of opposed aligned apertures 32-32 so the pin member 34 may pass through one of the apertures 32-32, through the opening 42, and then through the one remaining aperture of the pair of apertures 32-32. Referring again now to FIG. 2A there is more specifically seen a perspective view of the hitch member 22 after being slidably disengaged from the receiver assembly 12.

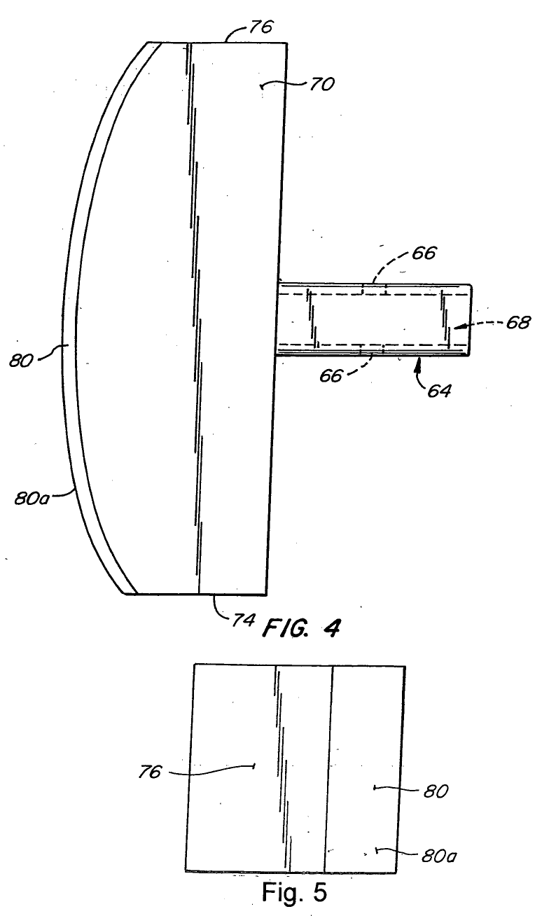

As best shown in FIGS. 2B-5 there is seen an embodiment of the step assembly, generally illustrated as 60, for engaging the receiver assembly 12. The step assembly 60 includes a step body 62 and a step support bar 64 connected to the step body 62 and having an opening 66 extending there through. In an embodiment of the invention the step support bar 64 includes a hollow inside 68 and a pair of opposed openings 66-66.

The step assembly 60 may be solid or hollow and may have any suitable shape. In an embodiment of the invention the step body 62 includes a bottom 70, a back 72 to which the step support bar 64 connects, a pair of ends 74 and 76, and a top 78 having a planar surface 78a upon which a person may place a foot to step upwardly. The step body 62 also includes a front 80 which in an embodiment of the invention has a generally arcuate surface 80a. The step assembly 60 may be manufactured from any suitable material, such as wood, plastic, or metal.

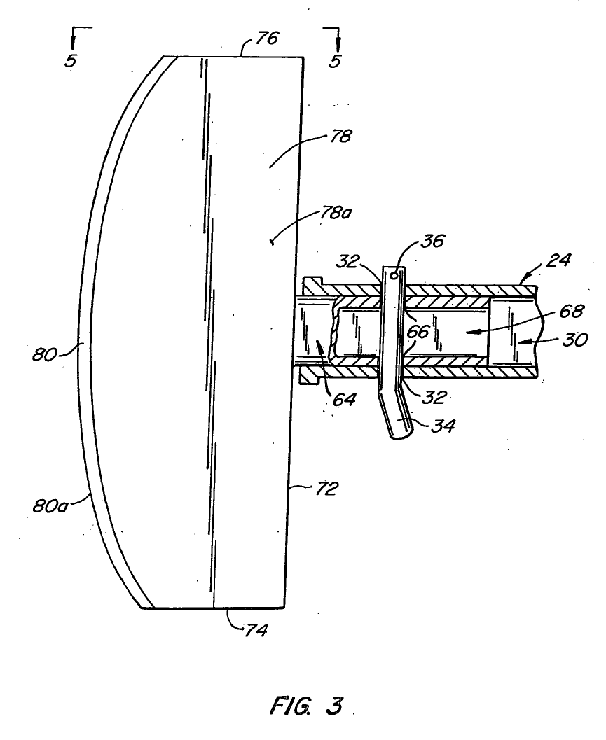

The step support bar 64 slidably passes into the hollow inside 30 of the conduit body 24 of the receiver assembly 12 until the openings 66-66 are aligned with the pair of opposed aligned apertures 32-32 so the pin member 34 may pass through one of the apertures 32-32, through one of the openings 66-66, and then through the one remaining aperture of the pair of apertures 32-32, and then through the one remaining opening of the pair of openings 66-66. After the pin member 34 has been inserted as such, as best shown in FIG. 3, the coupling pin 38 may be slidably passed into the bore 36 of the pin member 34. Referring again now to FIG. 2B there is more specifically seen a perspective view of the step assembly 60 spaced from and aligned with the receiver assembly 12 for slidably engaging the same.

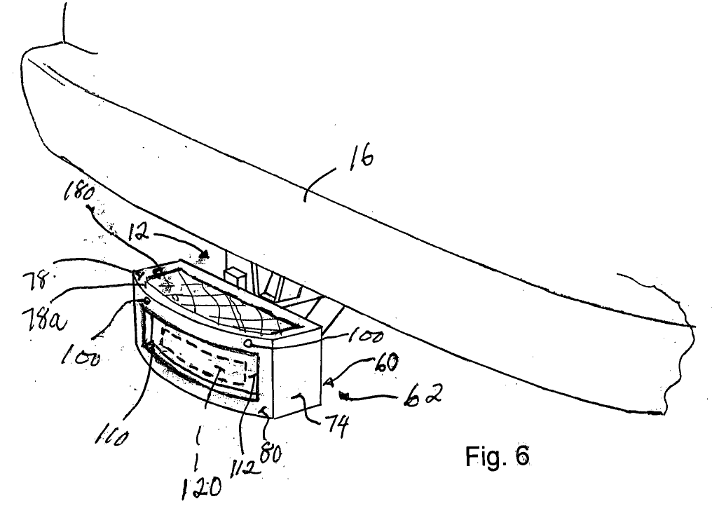

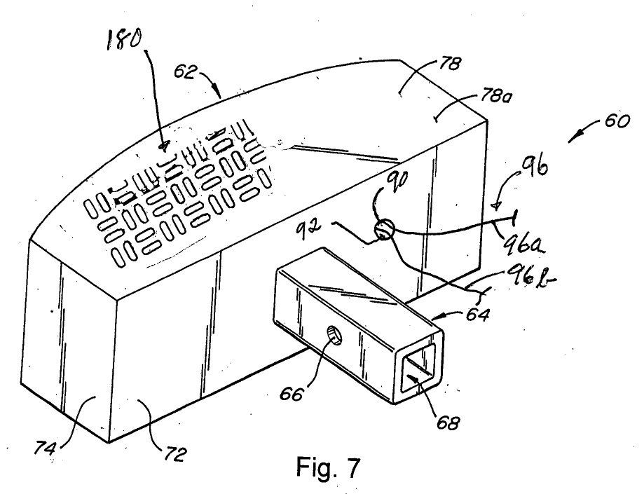

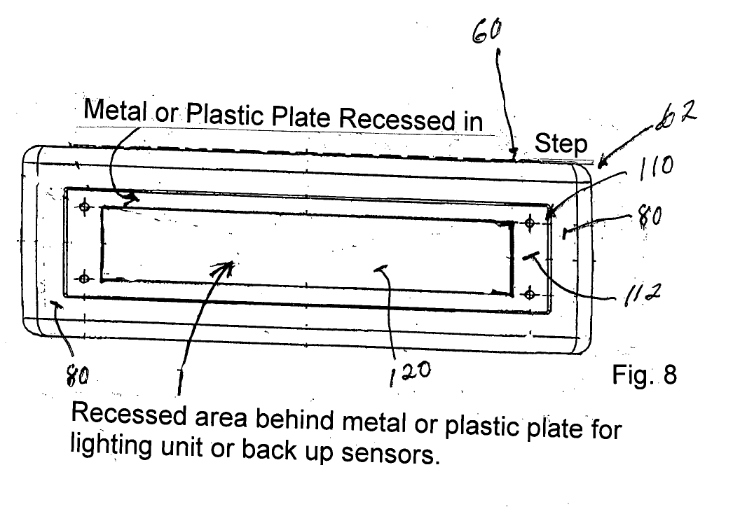

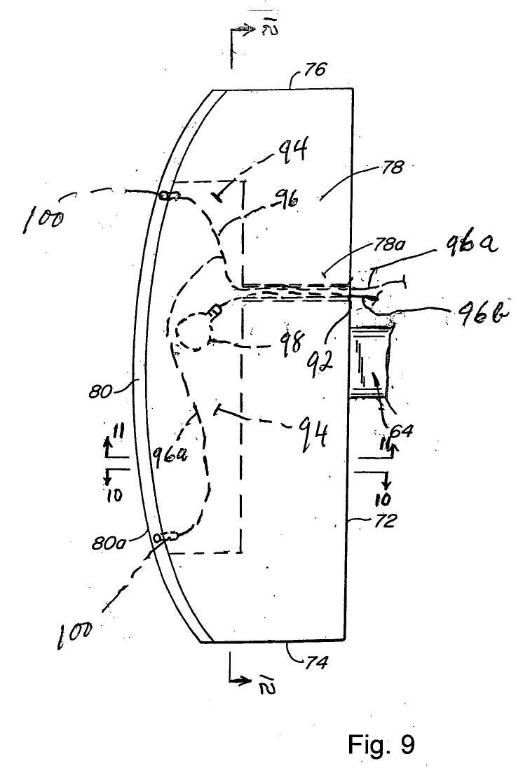

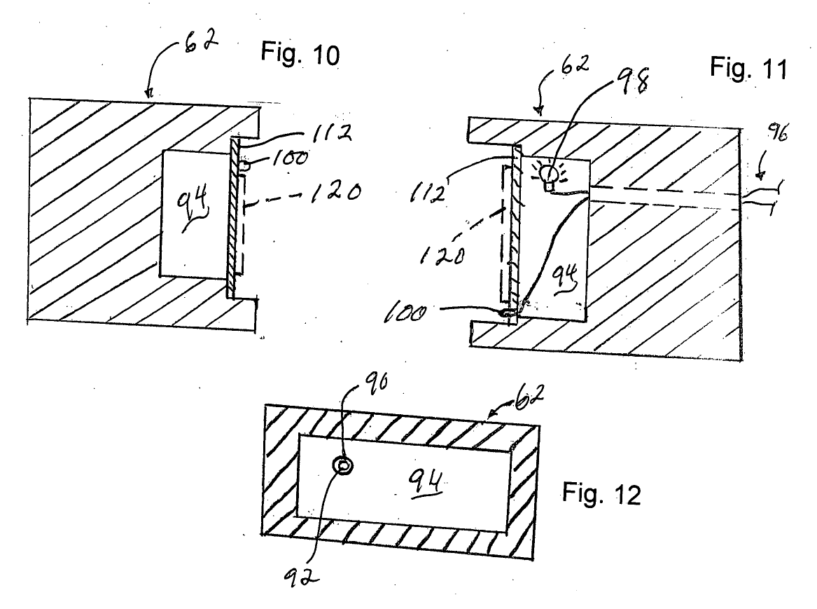

Referring in detail now to FIGS. 6-12, there is seen another embodiment of the step assembly 60. For this embodiment the step assembly 60, more particularly the step body 62, is manufactured from a compressible foam material, such as Styrofoam, or any other light weight material, such as a plastic foam, or the like. The light weight material is resilient for returning to its original position if disturbed (e.g., contacted by a bumper of another vehicle, etc). Thus, if any indentation of the light weight material occurs from an outside compressing force, the indentation is removed from the light weight material after the outside compressing force is released from against the light weight material. A suitable non-skid layer (or texture) 180 may be disposed on the top 78 of the step body 62.

The step body 62 includes a conduit opening 90 through which a conduit 92 extends and terminates in a cavity 94. One or more wires, generally illustrated as 96 and receiving power (i.e., electric current from the battery of the vehicle 14), pass through the conduit opening 90 and through the conduit 92. More specifically, wires 96 may include wires 96a and 96b for electrically coupling to a light member 98 and at least one sensor 100 (e.g., a back-up sensor for gauging the distance to an object). The light member 98 may function for any purpose, such as for brake lights and/or for pure illumination purposes. The sensor(s) 100 may be disposed at any suitable location on and in the step body 62 (as best shown in FIGS. 6 and 9-11).

The step body 62 (i.e., the front 80 including generally arcuate surface 80a) also includes a recess, generally illustrated as 110, whose bottom or rear wall 112 is a generally transparent plastic or metal wall member through which light may pass when the light member 98 is illuminated. A decal member 120 may be mounted (e.g., for advertising or marketing purposes) on the plastic or metal wall member 112. When the light member 98 is illuminated, light passes through the wall member 112 and illuminates the decal member 120. As previously indicated, the backup sensor(s) 100 may extend through, lodge in, or be supported by the plastic or metal wall member 112.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any directional arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for furnishing a step for a vehicle comprising:
providing a vehicle having a hitch assembly including a hitch member engaged to a receiver assembly;
removing the hitch assembly from the receiver assembly; and
engaging a step assembly to the receiver assembly for furnishing a step for the vehicle.

2. The method of claim 1 wherein said step assembly comprises a step body and a step support bar connected to the step body.

3. The method of claim 2 wherein said step body comprises a generally planar top and a front defining a generally arcuate surface.

4. The method of claim 3 wherein said step support bar comprises a generally hollow support bar having a pair of opposed openings.

5. The method of claim 3 wherein said receiver assembly comprises a generally hollow member having a pair of opposed apertures.

6. The method of claim 4 wherein said engaging a step assembly to the receiver assembly comprises sliding the generally hollow support bar into the generally hollow member and passing a pin through the opposed openings of the generally hollow support bar and through the opposed apertures of the generally hollow member.

7. The method of claim 2 additionally comprising illuminating a cavity within the step body.

8. The method of claim 2 wherein said step body comprises a resilient foam material.

9. A step assembly comprising a step body and a step support bar connected to the step body, said step support bar including a generally hollow support bar having a pair of opposed openings.

10. The step assembly of claim 9 wherein said step body comprises a generally planar top and a front defining an arcuate surface.

11. The step assembly of claim 9 additionally comprising a vehicle having a receiver assembly including a generally hollow member having a pair of opposed apertures, said generally hollow support bar slidably engaged with the generally hollow member, and a pin passing through the opposed openings of the generally hollow support bar and through the opposed apertures of the generally hollow member.

12. The step assembly of claim 9 wherein said step body comprises a cavity, and a recess having a generally transparent wall.

13. The step assembly of claim 12 additionally comprising a conduit extending through said step body and terminating in said cavity, a light member disposed in said cavity, and a wire member passing through the conduit and electrically coupled to the light member.

14. The step assembly of claim 12 additionally comprising a sensor member supported by said generally transparent wall.

15. The step assembly of claim 12 additionally comprising a decal member supported by said generally transparent wall.
